(19) United States
(12) Patent Application Publication
(10) Pub. No.: US 2026/0355964 A1
(43) Pub. Date: Nov. 12, 2026

(54) END EFFECTOR FOR OBJECT MANIPULATION

(71) Applicant: Agility Robotics, Inc., Pittsburgh, PA (US)

(72) Inventors: Isaiah Brand, Portland, OR (US); Jay Jasper, Corvallis, OR (US)

(21) Appl. No.: 19/310,775

(22) Filed: Aug. 26, 2025

Related U.S. Application Data
(60) Provisional application No. 63/803,290, filed on May 9, 2025.
(60) Provisional application No. 63/818,286, filed on Jun. 5, 2025.

(51) Int. Cl. B25J 9/16; B25J 15/00

(52) U.S. Cl. CPC B25J 9/1679; B25J 9/1664; B25J 15/0033

(57) ABSTRACT

An end effector for a robot system includes a base, a first paddle extending from the base, and a second paddle extending from the base. The first paddle, the second paddle, and the base are arranged to simultaneously contact, respectively, first, second, and third surfaces of a cuboid object perpendicular to one another at a corner region of the cuboid object. Additionally, at least one of the first and second paddles defines a negative region configured to receive an object handle. The first paddle and the second paddle are arranged in an L-shaped configuration relative to each other. The base includes a coupler configured to attach the end effector to a robot arm. The negative region is dimensioned to accommodate cylindrical handles. The first paddle comprises a proximal portion connected to the base, an intermediate portion, and a distal portion that includes a hook defining the negative region.

### CROSS-REFERENCE TO RELATED APPLICATION

This claims the benefit of U.S. Provisional Application No. 63/803,290 filed May 9, 2025 and U.S. Provisional Application No. 63/818,286 filed Jun. 5, 2025. The foregoing applications are incorporated herein by reference in their entirety. To the extent the foregoing applications or any other material incorporated by reference conflicts with the present disclosure, the present disclosure controls.

### FIELD

The present technology relates to end effectors for robot manipulation of objects, such as totes and boxes in industrial and logistics environments.

### BACKGROUND

Much of the work that humans currently perform is amenable to automation using robotics. For example, many human workers currently focus on executing predefined movements of items and containers at order-fulfillment centers. Such predefined movements may occur millions of times a day at a single order-fulfillment center and billions of times a day across a network of order-fulfillment centers. Human effort is better suited to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, an improved end effector for object manipulation is provided. The end effector includes two paddles, wherein at least one of the paddles includes a negative space forming a hook. The hook is configured to interact with object features including tote lips, drawer lips, door handles, and/or machine guard handles. According to other aspects of the present disclosure, the end effector may include one or more of the following features. The two paddles may be asymmetric, with one paddle being longer than the other. The hook may be configured to pull objects from above or below. The hook may be configured to securely hold objects from below, such as a tote edge projecting down into the negative space of the hook. The asymmetric design of the paddles may provide a greater set of end effector orientations for wedging between closely packed objects.

According to another aspect of the present disclosure, a method for manipulating objects using an improved end effector is provided. The method includes providing an end effector comprising two paddles, wherein at least one of the paddles includes a negative space forming a hook, and using the hook to interact with object features including tote lips, drawer lips, door handles, and machine guard handles. According to other aspects of the present disclosure, the method may include one or more of the following features. The method may include using the asymmetric design of the paddles to insert the end effector between closely packed objects. The method may include pulling objects from above or below using the hook. The method may include securely holding objects from below, such as a tote edge projecting down into the negative space of the hook.

According to another aspect of the present disclosure, a robot system for object manipulation is provided. The system includes a robot arm and an improved end effector attached to the robot arm. The end effector includes two paddles, wherein at least one of the paddles includes a negative space forming a hook. The hook is configured to interact with object features including tote lips, drawer lips, door handles, and/or machine guard handles. According to other aspects of the present disclosure, the robot system may include one or more of the following features. The two paddles of the end effector may be asymmetric, with one paddle being longer than the other. The hook may be configured to pull objects from above or below. The hook may be configured to securely hold objects from below, such as a tote edge projecting down into the negative space of the hook. The asymmetric design of the paddles may provide a greater set of end effector orientations for wedging between closely packed objects.

The foregoing general description of the illustrative embodiments and the following detailed description thereof are merely aspects of the teachings of this disclosure and are not restrictive.

### BRIEF DESCRIPTION OF FIGURES

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1 illustrates an isometric view of a mobile robot, according to aspects of the present disclosure.

FIGS. 2-3 are isometric views of an end effector for object manipulation, according to at least some embodiments of the present technology.

FIGS. 4-9 illustrate various profile views of the end effector of FIGS. 2-3, according to aspects of the present technology.

FIGS. 10 and 11 are side and perspective views, respectively, of the mobile robot of FIG. 1 interacting with a totes, according to at least some embodiments of the present technology.

FIG. 12 is a detail view corresponding to FIGS. 10 and 11.

FIGS. 13 and 14 are side and perspective views, respectively, of the mobile robot of FIG. 1 interacting with boxes, according to at least some embodiments of the present technology.

FIG. 15 is a detail view corresponding to FIGS. 13 and 14.

### DETAILED DESCRIPTION

The following description sets forth aspects of the present disclosure. It should be recognized, however, that such description is not intended as a limitation on the scope of the present disclosure. Rather, the description also encompasses combinations and modifications to those aspects described herein.

In recent years, the rapid growth of e-commerce and the increasing complexity of supply chain operations have created a need for more efficient and versatile automation solutions in order-fulfillment centers, warehouses, and manufacturing facilities. The demand for faster processing times, higher accuracy, and improved handling of diverse objects has driven the development of advanced robot systems capable of performing a wide range of manipulation tasks. One of the challenges in automating order-fulfillment processes lies in the ability to interact with a variety of objects with different shapes, sizes, and physical properties. Traditional robot end effectors often struggle to adapt to the diverse array of items found in modern warehouses, leading to inefficiencies and potential damage to goods. For example, an end effector optimized for interacting with boxes may be poorly suited for interacting with a handle. In manufacturing facilities, the need for flexible automation has become increasingly apparent as production lines are required to handle a growing variety of components and assemblies. The ability to quickly reconfigure robot systems to accommodate different products and manufacturing processes is important for maintaining competitiveness in rapidly changing markets. End effectors that can interact with diverse components, including those with handles or specialized features, can enhance the adaptability of robot systems in manufacturing environments. Distribution centers face similar challenges in terms of object manipulation, with the added complexity of high-speed sorting and packing operations. The efficiency of these facilities relies heavily on the ability to quickly and accurately handle items of varying sizes and shapes, often in tightly packed configurations. End effectors capable of inserting themselves between closely spaced objects and securely grasping items with different geometries can greatly improve the throughput and reliability of sorting and packing processes.

The trend towards high-density storage systems in warehouses and distribution centers has further emphasized the need for advanced robot manipulation capabilities. These systems maximize storage capacity by minimizing the space between stored items, creating challenges for traditional robot systems when retrieving or placing objects. End effectors designed to operate effectively in restricted spaces and interact with objects from multiple angles can significantly enhance the efficiency and utilization of high-density storage solutions. Conventional end effectors for robot systems often face limitations when handling diverse objects in industrial and logistical environments. These limitations can lead to inefficiencies, reduced versatility, and potential damage to handled items. An improved end effector design in accordance with at least some embodiments of the present technology addresses one or more challenges associated with traditional end effectors, enhancing their capabilities and expanding their range of applications. One limitation of some conventional end effectors is their difficulty in manipulating both objects with and without dedicated handles or gripping points. In at least some embodiments, the improved end effector incorporates features that enable interaction with a wide range of object features, including corners, tote lips, drawer lips, door handles, and machine guard handles. This versatility allows the end effector to securely grasp and manipulate objects that may have posed challenges for traditional designs, increasing the range of items that can be handled in automated systems. Secure holding of objects, especially those with irregular shapes or protruding features, can be challenging for conventional end effectors. In at least some embodiments, the improved design includes features that allow for secure holding of objects from below, such as accommodating a tote edge projecting down into negative spaces or hook-like structures. This capability enhances the stability and reliability of object manipulation, reducing the risk of dropped items and improving overall handling efficiency.

Many traditional end effectors struggle with inserting themselves between closely packed objects, a common requirement in high-density storage systems and tightly packed shelves. In at least some embodiments, the improved end effector incorporates an asymmetric design of its paddles, providing a greater set of orientations for wedging between boxes or other closely spaced objects. This feature enhances the end effector's ability to access and manipulate items in confined spaces, improving its effectiveness in densely packed environments. Conventional end effectors may also face challenges in performing bimanual manipulation tasks, particularly when handling cases or boxes without handles. In at least some embodiments, the improved design addresses this limitation by incorporating features that enable effective bimanual manipulation of such objects. This capability expands the range of items that can be handled efficiently, improving the versatility of robot systems in warehouse and manufacturing settings. By addressing these and/or other limitations of conventional technology, an improved end effector design in accordance with at least some embodiments of the present technology enhances the overall capabilities of robot manipulation systems. These advancements may lead to increased efficiency in order fulfillment processes, improved flexibility in manufacturing operations, and enhanced performance in high-density storage and retrieval systems. The combination of these features in a single end effector design represents a significant step forward in addressing the evolving needs of industrial and logistical automation.

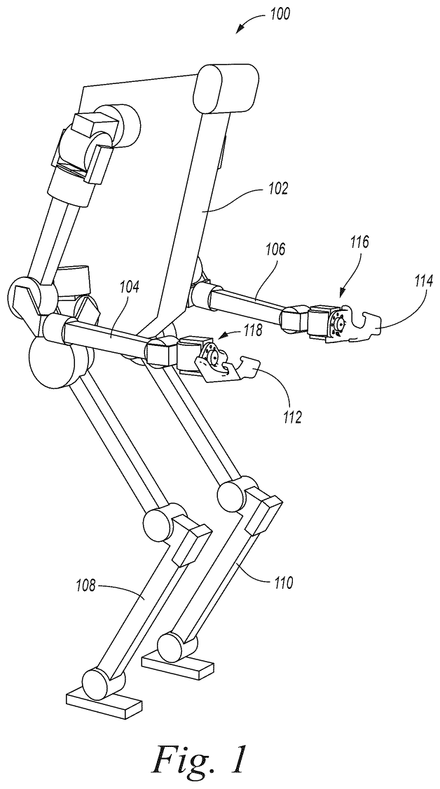

FIG. 1 illustrates an isometric view of a mobile robot according to at least some embodiments of the present technology. As shown in FIG. 1, the mobile robot 100 may include a torso 102 that serves as a central structure for the robot. The mobile robot 100 may be designed for various manipulation tasks in industrial and logistical environments. In some cases, the torso 102 may be configured to support multiple appendages and components of the mobile robot 100. The mobile robot 100 may include a first arm 104 and a second arm 106 extending from an upper portion of the torso 102. These arms 104, 106 may provide the mobile robot 100 with the capability to perform bimanual manipulation tasks, allowing for coordinated movement and object handling. The lower portion of the torso 102 may be connected to a first leg 108 and a second leg 110. These legs 108, 110 may provide support and mobility for the mobile robot 100, enabling the robot to move and maintain stability while performing various tasks. The configuration of the legs 108, 110 in relation to the torso 102 may allow for a stable base during manipulation operations. At the end of each arm 104, 106, the mobile robot 100 may be equipped with end effectors. A first end effector 112 may be attached to the first arm 104, while a second end effector 114 may be attached to the second arm 106. These end effectors 112, 114 may be designed for object manipulation and may serve as the primary interaction points between the mobile robot 100 and its environment. The mobile robot 100 may include connectors for attaching the end effectors to the arms. A first connector 116 may join the first end effector 112 to the first arm 104, and a second connector 118 may join the second end effector 114 to the second arm 106. These connectors 116, 118 may allow for the end effectors 112, 114 to be swapped or replaced with different types of end effectors as needed for various tasks.

The overall configuration of the mobile robot 100, with its torso 102, arms 104, 106, legs 108, 110, end effectors 112, 114, and connectors 116, 118, may enable the robot to perform a wide range of object handling operations. The arrangement of these components may allow for flexibility in movement and manipulation, adapting to different scenarios in industrial and logistical settings.

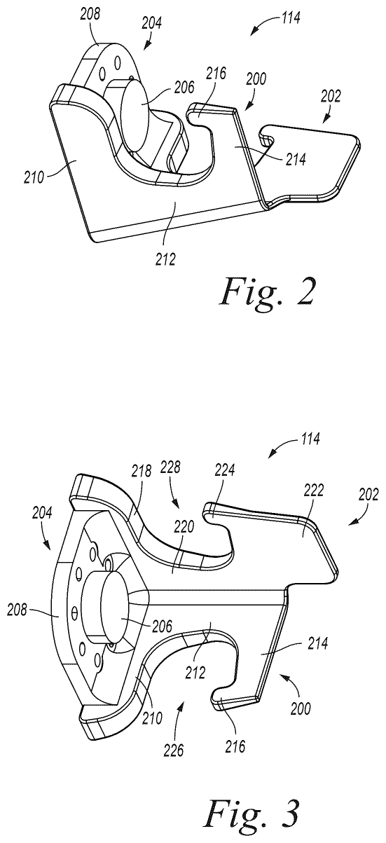

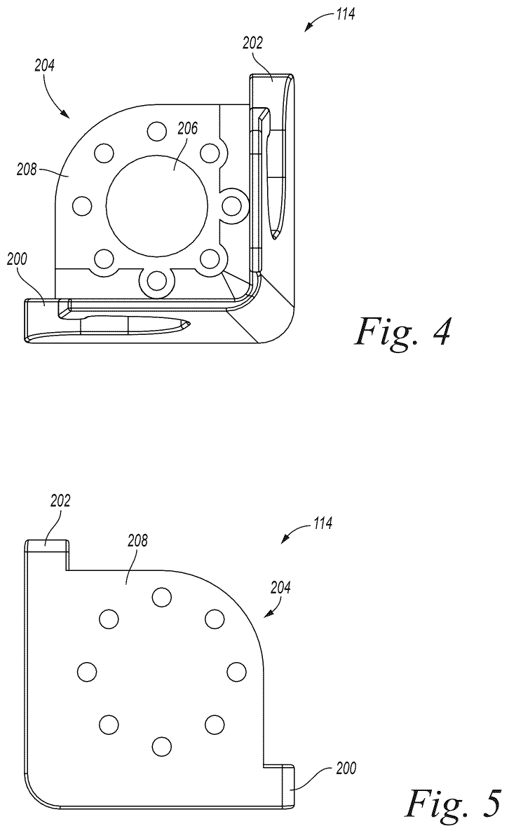

FIGS. 2-9 illustrate various views of the end effector 114. As shown in FIGS. 2-9, the end effector 114 may include a first paddle 200, a second paddle 202, and a base 204. In some cases, the first paddle 200 and the second paddle 202 may be arranged in an L-shaped configuration relative to each other. This arrangement may allow the end effector 114 to interact with objects from multiple sides simultaneously. The base 204 may include a platform 206 and a coupler 208. The coupler 208 may be configured to attach the end effector 114 to a robot arm, such as the arm 104 or arm 106 of the mobile robot 100. The first paddle 200 may comprise a proximal portion 210 connected to the base 204, an intermediate portion 212, and a distal portion 214. In some cases, the distal portion 214 may include a hook 216. Relatedly, the first paddle 200 may define a negative region 226 adjacent to the hook 216. Similarly, the second paddle 202 may comprise a proximal portion 218 connected to the base 204, an intermediate portion 220, and a distal portion 222. The distal portion 222 may include a hook 224 Similar to the first paddle 200, the second paddle 202 may define a negative region 226 adjacent to the hook 224. These negative regions 226, 228 may be configured to receive object handles, potentially accommodating cylindrical handles or other shapes.

In at least some embodiments, the hook structures 216, 224 formed at the distal ends of the paddles 200, 202 may be J-shaped. This J-shaped configuration provides several advantages for object manipulation, including a secure enclosure for handles, a natural entry path for the handle during engagement, and a reliable retention mechanism during movement. The curved portion of the J-shape creates a partial enclosure that prevents lateral displacement of the engaged handle while still allowing for easy insertion and removal when needed. The J-shaped hook structure may have an inner radius dimensioned to accommodate standard industrial handle diameters, typically ranging from 10 mm to 30 mm, while the opening of the “J” may be oriented to facilitate approach from the most common angle of engagement for the specific application. In at least some embodiments, the first paddle 200, the second paddle 202, and the base 204 may be arranged to simultaneously contact first, second, and third surfaces of a cuboid object perpendicular to one another at a corner region of the cuboid object. This configuration may allow the end effector 114 to securely grasp and manipulate box-like objects from multiple sides simultaneously. In some cases, at least one of the first paddle 200 and the second paddle 202 may include an aligning surface configured to guide the end effector 114 into position relative to an object. For example, the end effector 114 may include aligning surfaces 230, 232, and 234. These aligning surfaces may help promote proper positioning of the end effector 114 relative to the object being manipulated, potentially improving the accuracy and reliability of grasping operations. In at least some embodiments, the arrangement of the paddles 200, 202 and their associated features may provide the end effector 114 with versatility in handling various object types. The combination of the L-shaped configuration, hook structures, and negative regions may allow the end effector 114 to interact with objects having handles, lips, or other protrusions, as well as smooth-surfaced objects like boxes or totes.

In at least some embodiments, the first paddle 200 may extend further from the base 204 than the second paddle 202. This asymmetric design may provide additional flexibility in object manipulation, potentially allowing the end effector 114 to reach into tight spaces or between closely packed objects. The difference in paddle length may also contribute to the end effector's ability to handle objects of various sizes and shapes. In some implementations, the first paddle 200 may extend at least 10% further from the base 204 than the second paddle 202, though other embodiments may feature different extension ratios. For example, the first paddle 200 may extend 15%, 20%, 25%, 30%, 40%, or 50% further from the base 204 than the second paddle 202, depending on the specific application requirements. In certain specialized applications, the extension difference may be as high as 75% to 100%. This asymmetry may provide an advantage when manipulating objects in confined spaces or when precise insertion between tightly packed items is required. The base 204, including the platform 206 and coupler 208, may provide a stable foundation for the paddles 200, 202. The platform 206 may serve as a structural support, while the coupler 208 may facilitate secure attachment to a robot arm. This configuration may allow for precise control of the end effector 114 during manipulation tasks. The geometry of the end effector 114 can be designed to optimize its functionality across a wide range of manipulation tasks. The overall structure can follow a three-dimensional arrangement where the first paddle 200 and second paddle 202 extend from the base 204 at approximately 90-degree angles relative to each other, creating the characteristic L-shaped configuration that enables simultaneous contact with perpendicular surfaces of a target object. The first paddle 200 may have a length ranging from 100 mm to 250 mm, while the second paddle 202 may be proportionally shorter based on the asymmetric design ratio selected for the specific application. Both paddles may feature a width-to-thickness ratio that balances structural rigidity with weight considerations. The distal portions 214, 222 of the paddles may incorporate curved sections that transition into the hook structures 216, 224, with the curvature radius configured to accommodate target handle sizes while maintaining sufficient material strength. The negative regions 226, 228 formed by these hooks may have an opening width of 10 mm to 30 mm and a depth of 15 mm to 50 mm. The aligning surfaces 230, 232, 234 may feature subtle chamfers or bevels, typically at angles between 30 and 45 degrees, that guide the end effector into proper alignment during approach maneuvers. The platform 206 may be perpendicular to both paddles, completing the three-dimensional corner engagement geometry and providing additional contact surface area for stabilizing manipulated objects.

In at least some embodiments, the hook structures 216, 224 include reinforced edges with hardened material to withstand repeated contact with metal handles and other rigid object features. The hooks may incorporate a non-slip surface treatment or coating on their interior surfaces to enhance grip security when engaging with smooth handles. The negative regions 226, 228 may feature variable depths within the same hook structure to accommodate handles of different diameters while maintaining optimal contact pressure. In some cases, a counterpart of the hook structures 216, 224 is a reconfigurable hook mechanism that can dynamically adjust its curvature to match different handle geometries. In some cases, a counterpart of the negative regions 226, 228 includes integrated pressure sensors that provide feedback about the security of the grasp, enabling the robot system to make real-time adjustments to maintain optimal grip force during manipulation tasks. In at least some embodiments, the aligning surfaces 230, 232, 234 include tactile sensors that detect contact with object surfaces and provide feedback to guide precise positioning. The aligning surfaces may incorporate visual markers or patterns that can be detected by the robot's vision system to assist with alignment verification during approach and engagement operations. In some cases, a counterpart of the aligning surfaces 230, 232, 234 is a set of retractable alignment pins that extend during the approach phase to guide the end effector into position and then retract once proper alignment is achieved. In some cases, a counterpart of the L-shaped configuration of the paddles is an adjustable-angle arrangement where the relative orientation of the paddles can be modified to accommodate objects with non-perpendicular surfaces.

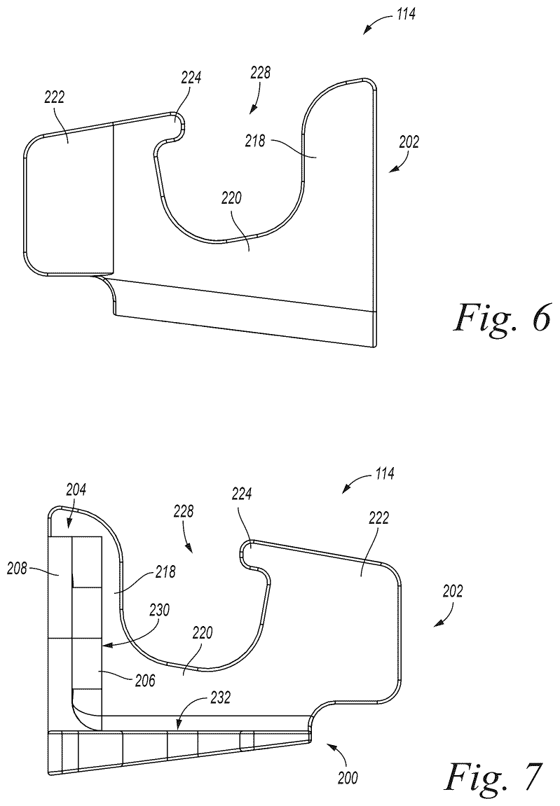

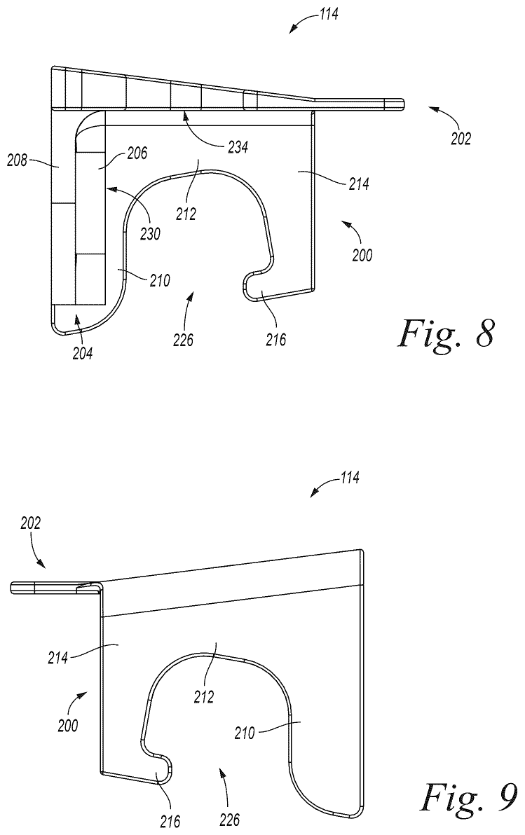

FIGS. 10-12 illustrate various views of a mobile robot 100 interacting with objects according to at least some embodiments of the present technology. As shown in FIGS. 10-12, the mobile robot 100 may include end effectors 112, 114 designed to manipulate objects such as a tote 300 and a tote 302 and to interact with object features such as a handle 306. In at least some embodiments, the mobile robot 100 may approach a table 304 on which objects are placed. The table 304 may provide a support surface for the tote 300 and the tote 302, allowing the mobile robot 100 to perform picking and placing operations. The torso 102 of the mobile robot 100 may be positioned to allow the arms 104, 106 to extend and reach the objects on the table 304 effectively. The end effector 112 may be configured to interact with various object features, including handles and similar structures. In some cases, the negative region 226 defined by the hook 216 of the paddle 200 may be specifically designed to accommodate and engage with handles of different shapes and sizes. This configuration may allow the end effector 112 to securely grasp and manipulate objects that have various types of handles or handle-like protrusions. FIG. 12 provides a detailed view of how the end effector 112 may interact with a handle 306. The negative region 226 of the end effector 112 may be positioned to align with the handle 306, allowing for a secure engagement. In some cases, the hook 216 may partially or fully encircle the handle 306, providing a stable grip for lifting, pulling, or otherwise manipulating the object to which the handle 306 is attached.

In some implementations, the contact between the handle and the border of the negative region may vary depending on the specific design of the end effector and the handle geometry. For example, the hook may engage with approximately 180 degrees of the handle's circumference, providing a secure grip while still allowing for easy insertion and removal. In other cases, the contact may extend to around 270 degrees of the handle's circumference, offering increased stability for heavier objects or during more dynamic movements. Some designs may allow for adjustable contact, ranging from 90 degrees for quick, low-force manipulations up to 330 degrees for maximum security in challenging environments. The specific contact area may be tailored to balance factors such as grip strength, ease of engagement, and versatility across different handle types. Moreover, the design of the end effector 112 may allow for versatile interaction with different types of handles. For example, the negative region 226 may be dimensioned to accommodate cylindrical handles commonly found on industrial containers or equipment. In some cases, the shape of the hook 216 may be tailored to match specific handle geometries, enhancing the end effector's ability to securely grasp and manipulate objects with various handle designs.

In at least some embodiments, the negative region 226 includes a variable-depth profile that enables secure engagement with handles of different diameters within a single hook design. The hook 216 may incorporate a self-centering geometry that guides handles toward an optimal position within the negative region 226 during engagement, improving grasp reliability even with imprecise initial positioning. In some cases, a counterpart of the negative region 226 is an adaptive cavity with mechanically or pneumatically adjustable dimensions that can conform to handles of various shapes and sizes. In some cases, a counterpart of the hook 216 is a multi-segment articulated hook that can reconfigure its shape to optimize the grasp for different handle geometries, including rectangular, triangular, or irregularly shaped handles. The ability of the end effector 112 to interact with handles may significantly expand the range of objects that the mobile robot 100 can manipulate. This capability may be particularly useful in industrial and logistical settings where objects with handles, such as totes, containers, or specialized equipment, are common. The end effector's design may allow the mobile robot 100 to perform tasks such as retrieving items from shelves, moving containers between workstations, or operating equipment with handle-based controls. In some cases, both the end effector 112 and the end effector 114 may be equipped with similar hook structures and negative regions. This configuration may allow the mobile robot 100 to perform bimanual manipulation tasks involving objects with multiple handles or requiring coordinated grasping from different angles. The ability to use both end effectors in conjunction may enhance the mobile robot's dexterity and expand its capabilities in complex manipulation scenarios. The interaction between the end effector 112 and the handle 306 may involve more than just grasping. In some cases, the negative region 226 and hook 216 may be designed to allow for rotational movement of the handle 306 within the end effector's grasp. This feature may be useful for manipulating objects with rotating or pivoting handles, such as certain types of industrial equipment or containers with adjustable handles.

In at least some embodiments, the mobile robot 100 includes coordinated control algorithms that enable synchronized movement of both end effectors 112, 114 during bimanual manipulation tasks. The robot may incorporate force feedback mechanisms that allow it to detect and respond to resistance when manipulating objects, adjusting its approach or grip strength accordingly. In some cases, a counterpart of the bimanual manipulation capability is a hybrid approach where one end effector uses the hook-based design for handle engagement while the other employs a different grasping mechanism such as vacuum suction or finger-like grippers to contact other surfaces of the same object. In some cases, a counterpart of the mobile robot 100 is a fixed-base robot system with multiple articulated arms that can perform similar manipulation tasks in environments where mobility is not required.

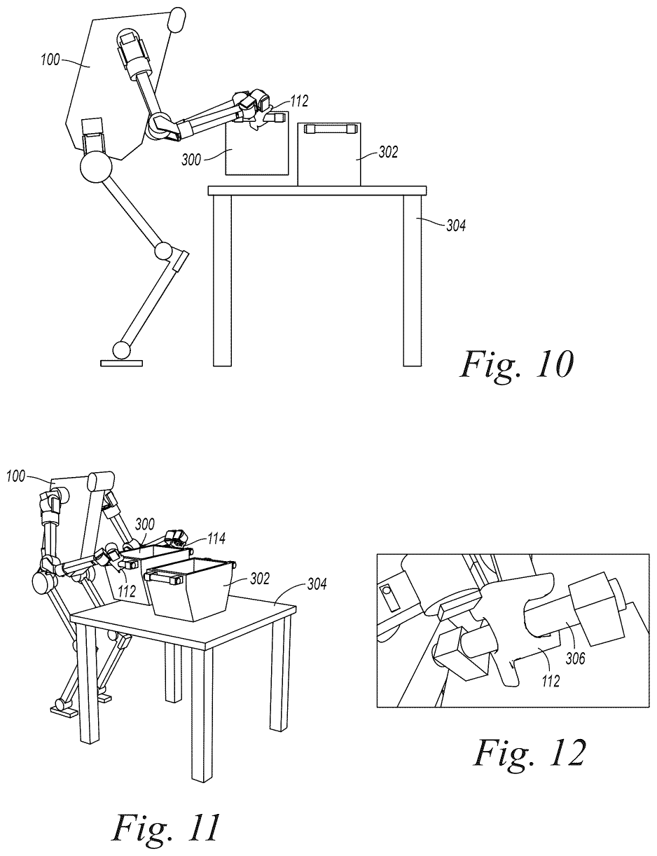

FIGS. 13-15 illustrate various views of a mobile robot 100 interacting with tightly packed objects according to at least some embodiments of the present technology. As shown in FIGS. 13-15, the mobile robot 100 may include end effectors 112, 114 designed to manipulate objects such as a boxes 400, 402, 404 positioned on a table 406. In some cases, the mobile robot 100 may approach the table 406 on which the boxes 400, 402, 404 are placed. The table 406 may provide a support surface for the boxes, allowing the mobile robot 100 to perform manipulation tasks such as picking, placing, or rearranging the boxes. The torso 102 of the mobile robot 100 may be positioned to allow the arms 104, 106 to extend and reach the boxes on the table 406 effectively. The end effectors 112, 114 may be specifically designed to interact with tightly packed objects, such as the boxes 400, 402, 404. In some cases, the boxes may be positioned close together, creating challenges for conventional end effectors. However, the asymmetric design of the end effectors 112, 114, with one paddle extending further than the other, may provide significant advantages in these scenarios.

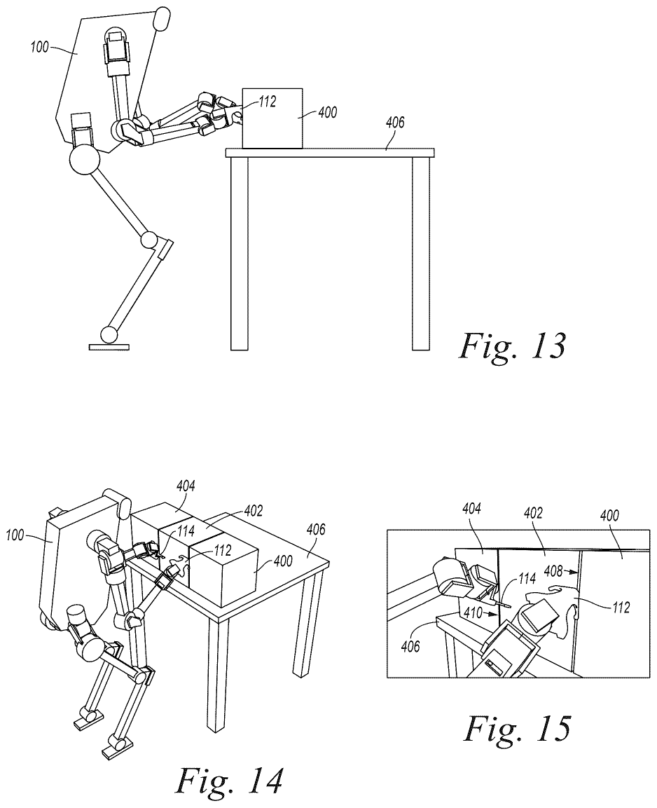

FIG. 15 illustrates a detail view of the arrangement, showing gaps 408, 410 between the boxes 400, 402, 404. These gaps may be relatively narrow, requiring precise manipulation capabilities from the end effectors 112, 114. The asymmetric design of the paddles on the end effectors 112, 114 may allow for improved insertion capabilities between the tightly packed boxes. In some cases, the longer paddle may be used to initially wedge between two boxes. The mobile robot 100 may then reposition the box enough to allow the shorter paddle to follow. In at least some embodiments, the longer paddle includes a progressive taper along its length, with the thickness decreasing toward the distal end to facilitate insertion into narrow gaps. The paddle surface, e.g., at the distal end portion, may incorporate a low-friction coating or material to reduce resistance when sliding between tightly packed objects. Thus, in at least some embodiments, the coefficient of friction of the distal portion of the longer paddle may be lower than that of more proximal portions of the paddle.

The asymmetric design may enable the end effector to approach objects from multiple angles, providing operational flexibility when access is limited from certain directions. In some cases, a counterpart of the asymmetric paddle design is a telescoping paddle that can extend or retract based on the specific requirements of the manipulation task. In some cases, a counterpart of the tapered edge is an active edge with vibration capabilities that can reduce friction and facilitate insertion between tightly packed objects through micro-movements. The ability of the end effectors 112, 114 to navigate these tight spaces may be further enhanced by the tapered edges of the paddles. These tapered edges may facilitate the insertion of the paddles into narrow gaps between objects, reducing the risk of disturbing adjacent boxes during manipulation tasks. This feature may be particularly useful in scenarios where maintaining the arrangement of surrounding objects is useful, such as in organized storage systems or during precise picking operations. In some cases, the hooks and negative regions incorporated into the paddles of the end effectors 112, 114 may provide additional functionality when interacting with tightly packed objects. These features may allow the end effectors 112, 114 to engage with edges, lips, or handles of boxes even in confined spaces. For example, the hook structures may be used to pull a box forward slightly, creating more space for the end effector to fully engage with the target object.

In at least some embodiments, the end effectors 112, 114 include integrated force sensors that detect contact forces during insertion between objects, allowing the robot to adjust its approach to minimize disturbance to adjacent items. The robot control system may incorporate path planning algorithms specifically optimized for navigating the end effectors through narrow gaps, using real-time feedback to make micro-adjustments during the insertion process. In some cases, a counterpart of the gap navigation capability is an approach that combines visual sensing with predictive modeling to identify optimal insertion paths before physical contact is made. In some cases, a counterpart of the bimanual manipulation strategy is a coordinated system where one end effector creates and maintains separation between objects while the other performs the primary manipulation task. The arrangement of the boxes 400, 402, 404 on the table 406, as shown in FIG. 14, may represent a typical scenario encountered in warehouse or distribution center environments. The mobile robot 100, equipped with the specialized end effectors 112, 114, may be capable of efficiently manipulating these tightly packed objects without the need for extensive rearrangement of surrounding items. This capability may significantly enhance the efficiency of picking and placing operations in high-density storage environments. The coordination between the two end effectors 112, 114, as illustrated in FIG. 14, may allow for bimanual manipulation of objects in tightly packed scenarios. In some cases, one end effector may be used to create space or stabilize surrounding objects, while the other end effector performs the primary manipulation task. This coordinated approach may further enhance the mobile robot's ability to handle complex arrangements of tightly packed objects. In at least some embodiments, the mobile robot 100 includes advanced vision systems that can identify optimal grasp points on objects even when they are partially occluded by adjacent items. The robot may employ learning-based approaches that improve its manipulation strategies over time based on successful and unsuccessful attempts at handling tightly packed objects. In some cases, a counterpart of the bimanual coordination capability is a system that can dynamically switch between different manipulation strategies based on real-time assessment of the arrangement and stability of objects in the workspace. In some cases, a counterpart of the end effector design is a modular system where different paddle configurations can be rapidly swapped to address specific challenges in various dense packing scenarios.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein. Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, or generating information in accordance with various embodiments of the present technology encompass, when feasible, the others of receiving, determining, and generating the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

1-20. (canceled)

21. A method of manipulating an object with a robot end effector, comprising:
positioning the robot end effector adjacent to the object, wherein the robot end effector includes a first paddle and a second paddle extending from a base, and at least one of the first and second paddles defines a negative region;
aligning the negative region with a handle of the object; and
engaging the handle with the negative region to manipulate the object.

22. The method of claim 21, wherein the negative region is defined by a hook structure formed at a distal end of at least one of the first and second paddles.

23. The method of claim 22, wherein the hook structure is J-shaped.

24. The method of claim 21, wherein both the first and second paddles define respective negative regions configured to receive the handle.

25. The method of claim 21, further comprising aligning the first paddle, the second paddle, and the base to simultaneously contact, respectively, first, second, and third surfaces of the object perpendicular to one another at a corner region of the object.

26. The method of claim 25, wherein at least one of the first and second paddles includes an aligning surface, and the method further comprises using the aligning surface to guide the end effector into position relative to the object.

27. The method of claim 21, wherein engaging the handle with the negative region comprises:
inserting the handle into the negative region; and
applying a force to manipulate the object using the engaged handle.

28. A method of manipulating an object with a robot end effector, comprising:
positioning the robot end effector adjacent to the object, wherein the robot end effector includes a first paddle and a second paddle extending from a base, and the first paddle extends further from the base than the second paddle;
inserting the first paddle between the object and an adjacent object; and
manipulating the object using the first paddle.

29. The method of claim 28, wherein the first paddle extends at least 10% further from the base than the second paddle.

30. The method of claim 28, wherein the first paddle comprises a tapered edge, and inserting the first paddle between the object and the adjacent object comprises using the tapered edge to facilitate insertion.

31. The method of claim 28, further comprising aligning the first paddle, the second paddle, and the base to simultaneously contact, respectively, first, second, and third surfaces of the object perpendicular to one another at a corner region of the object.

32. The method of claim 31, wherein at least one of the first and second paddles includes an aligning surface, and the method further comprises using the aligning surface to guide the end effector into position relative to the object.

33. The method of claim 28, wherein manipulating the object using the first paddle comprises applying a force to the object with the first paddle to move the object relative to the adjacent object.

34. The method of claim 33, wherein applying the force to the object with the first paddle comprises lifting the object away from a surface supporting the object and the adjacent object.

35. A method of manipulating an object with a robot end effector, comprising:
positioning the robot end effector adjacent to the object, wherein the robot end effector includes a first paddle and a second paddle extending from a base, the first paddle extends further from the base than the second paddle, and at least one of the first and second paddles defines a negative region;
inserting the first paddle between the object and an adjacent object;
aligning the negative region with a handle of the object; and
engaging the handle with the negative region to manipulate the object.

36. The method of claim 35, wherein the negative region is defined by a hook structure formed at a distal end of at least one of the first and second paddles.

37. The method of claim 36, wherein the hook structure is J-shaped.

38. The method of claim 35, wherein engaging the handle with the negative region comprises:
inserting the handle into the negative region; and
applying a force to manipulate the object using the engaged handle.

39. The method of claim 35, wherein the first paddle extends at least 10% further from the base than the second paddle.

40. The method of claim 39, wherein the first paddle comprises a tapered edge, and inserting the first paddle between the object and the adjacent object comprises using the tapered edge to facilitate insertion.
